(19) United States
(12) Patent Application Publication
(10) Pub. No.: US 2021/0316607 A1
(43) Pub. Date: Oct. 14, 2021

(54) AUTOMATIC TRANSMISSION

(71) Applicant: Isuzu Motors Limited, Tokyo (JP)

(72) Inventor: Yousuke TAKAHASHI, Fujisawa-shi, Kanagawa (JP)

(73) Assignee: Isuzu Motors Limited, Tokyo (JP)

(21) Appl. No.: 17/273,338

(22) PCT Filed: Sep. 4, 2019
(86) PCT No.: PCT/JP2019/034767

§ 371 Date: Mar. 4, 2021

(30) Foreign Application Priority Data
Sep. 5, 2018 (JP) 2018-165804

(51) Int. Cl. B60K 17/06; F16H 63/02; F16H 61/30; F16H 61/00; F15B 15/20

(52) U.S. Cl. CPC B60K 17/06; F16H 63/02; F15B 15/20; F16H 61/0009; F16H 61/30

(57) ABSTRACT

Provided is an automatic transmission which can suppress increase in size. The automatic transmission includes: a transmission mechanism (40) which is disposed in a transmission mechanism storage chamber (4) and has a plurality of transmission elements; a clutch (30) which is disposed in a clutch storage chamber (3), and connects and disconnects power delivery from a driving source to the transmission mechanism (40); and a first control unit (60) which stores first hydraulic control valves (62, 63) that control the transmission mechanism (40), wherein the first control unit (60) is disposed in the clutch storage chamber (3).

### TECHNICAL FIELD

The present disclosure relates to an automatic transmission.

### BACKGROUND ART

An automatic transmission has been known in which a first valve body that houses a control value for controlling a clutch is disposed in a clutch housing chamber, and a second valve body that houses a control valve for controlling gear-shifting is disposed in a transmission mechanism housing chamber, heretofore (e.g., see Patent Literature (hereinafter, referred to as “PTL”) 1).

### CITATION LIST

### Patent Literature

PTL 1
Japanese Patent Application Laid-Open No. 2007-263359

### SUMMARY OF INVENTION

### Technical Problem

In the automatic transmission described in PTL 1, since the first valve body is disposed in the clutch housing chamber and the second valve body is disposed in the transmission mechanism housing chamber, an oil passage connecting between both of the valve bodies increases in length, which results in a problem in that the automatic transmission increases in size.

An object of the present disclosure is thus to provide an automatic transmission capable of suppressing an increase in size.

### Solution to Problem

An automatic transmission according to one aspect of the present disclosure includes: a transmission mechanism disposed in a transmission mechanism housing chamber and having a plurality of gear-shifting elements; a clutch disposed in a clutch housing chamber and configured to connect and/or disconnect power transmission from a driving source to the transmission mechanism; and a first control unit that houses a first hydraulic control valve configured to control the transmission mechanism, in which the first control unit is disposed in the clutch housing chamber.

### Advantageous Effects of Invention

According to the automatic transmission of the present disclosure, it is made possible to suppress an increase in size.

### BRIEF DESCRIPTION OF DRAWINGS

FIG. 1A is a schematic cross-sectional view of an automatic transmission according to a first embodiment;

FIG. 1B is a cross-sectional view taken along 1B-1B of FIG. 1A;

FIG. 1C is a cross-sectional view taken along 1C-1C of FIG. 1A;

FIG. 2 is a diagram illustrating a hydraulic circuit from an oil pump to a gear-shifting control actuator;

FIG. 3 is a schematic cross-sectional view of an automatic transmission according to a second embodiment; and

FIG. 4 is a schematic cross-sectional view of an automatic transmission according to a third embodiment.

### DESCRIPTION OF EMBODIMENTS

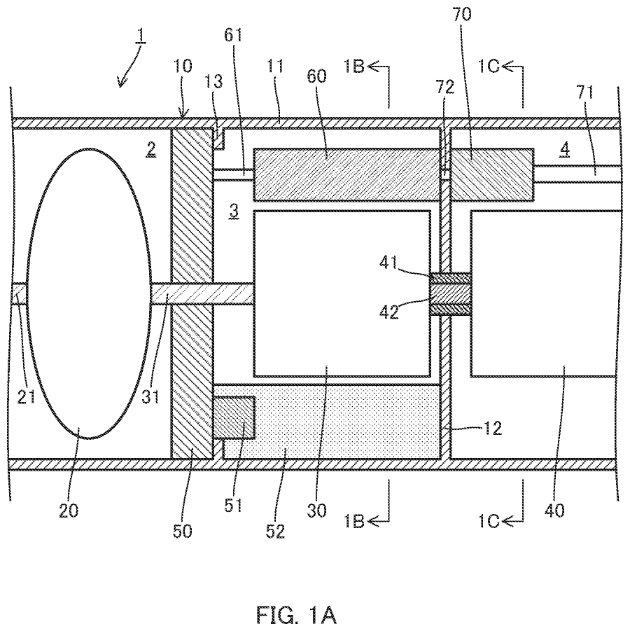

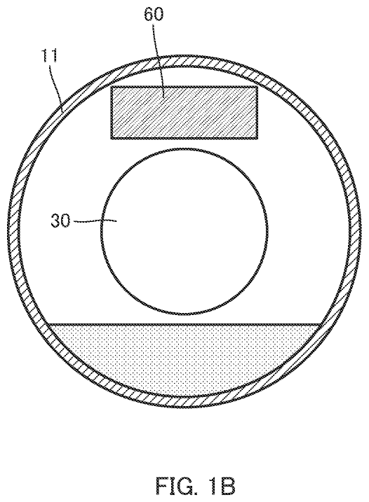

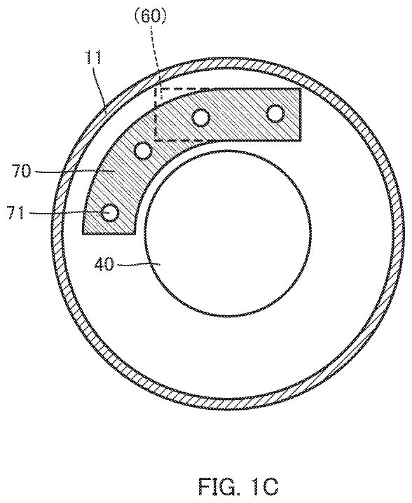

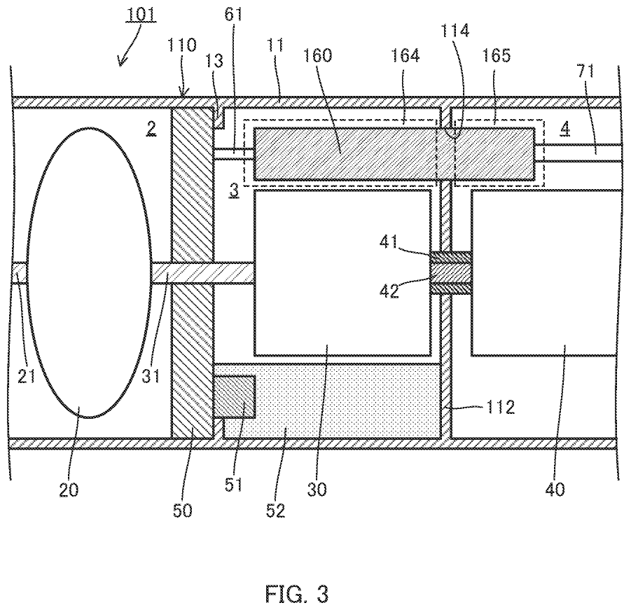

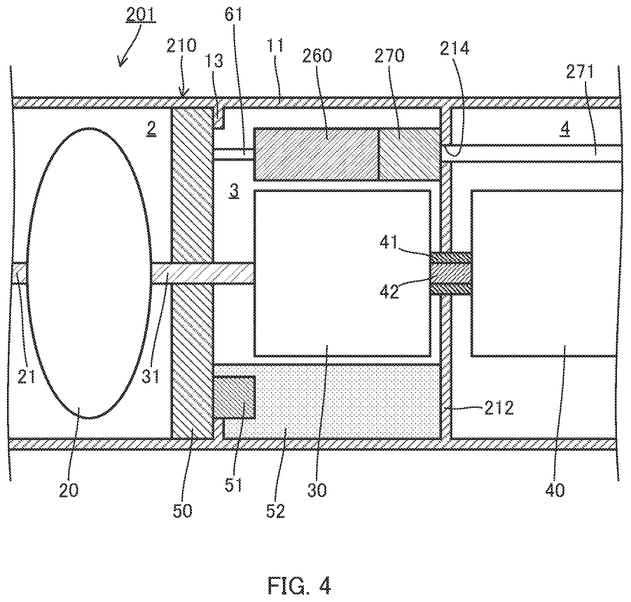

Hereinafter, embodiments of the present disclosure will be described in detail with reference to the drawings. Note that the embodiments described below are only exemplary, and the present disclosure is not limited to these embodiments. Further, the left and right direction is referred to as a “front-rear direction” or an “axial direction,” while the left side is referred to as a “front side,” and the right side is referred to as a “rear side” in FIG. 1A, FIG. 3, and FIG. 4.

### First Embodiment

FIG. 1A is a schematic cross-sectional view of automatic transmission 1 according to a first embodiment of the present disclosure. Automatic transmission 1 includes torque converter 20 coupled to a driving source (not illustrated), clutch 30, transmission mechanism 40, clutch control unit 50, gear-shifting control unit 60, and gear-shifting control actuator unit 70.

Automatic transmission 1 includes housing 10 which houses torque converter 20, clutch 30 and transmission mechanism 40. Housing 10 is a component having a substantially cylindrical shape, which is formed as a single unit by, for example, aluminum die-casting. Note that, housing 10 may be configured in such a manner that separately-formed parts are coupled together, instead of being formed as a single unit.

Housing 10 includes peripheral wall 11 having a substantially cylindrical shape. The front end in the axial direction of housing 10 (left end in FIG. 1A) is open. The middle portion of housing 10 in the axial direction is provided with partition wall 12 which is substantially perpendicular to the axial direction, and housing 10 is partitioned in the front and rear direction by partition wall 12.

Further, clutch control unit 50 extending in a direction substantially perpendicular to the axial direction is disposed between the front end and partition wall 12 of housing 10, and housing 10 is partitioned in the front and rear direction by clutch control unit 50.

Torque converter 20 is housed in torque converter housing chamber 2 surrounded by peripheral wall 11 and clutch control unit 50. Clutch 30 is housed in clutch housing chamber 3 surrounded by peripheral wall 11, clutch control unit 50 and partition wall 12. Transmission mechanism 40 is housed in transmission mechanism housing chamber 4 surrounded by peripheral wall 11 and partition wall 12.

Torque converter 20 transmits power from the driving source to clutch 30. Torque converter 20 includes a pump coupled to output shaft 21 of the driving source, a turbine coupled to input shaft 31 of clutch 30, a stator, and a lock-up clutch for directly coupling the pump and the turbine.

In FIG. 1A, only the outer shape of torque converter 20 is illustrated, and illustration of the inner structure of torque converter 20 is omitted. Incidentally, torque converter 20 may be one that is a fluid coupling having no stator or one that has no lock-up clutch. Further, torque converter 20 may be omitted.

Clutch 30 connects and/or disconnects transmission of the power transmitted via torque converter 20 to transmission mechanism 40. Clutch 30 is a hydraulically actuated wet multi-plate clutch. Note that clutch 30 is not limited to a hydraulically actuated wet multi-plate clutch.

In the present embodiment, transmission mechanism 40 disposed at a subsequent stage of clutch 30 is a dual clutch type transmission having first input shaft 41 and second input shaft 42. Therefore, clutch 30 has a first clutch for connecting and/or disconnecting the power transmission from input shaft 31 to first input shaft 41 of transmission mechanism 40, and a second clutch for connecting and/or disconnecting the power transmission from input shaft 31 to second input shaft 42 of transmission mechanism 40. In FIG. 1A, only the outer shape of the clutch 30 is illustrated, and illustration of the inner structure of clutch 30 is omitted.

Clutch control unit 50 is attached to fixing portion 13 protruding from peripheral wall 11 on the inner diameter side, using a fixing unit, such as a bolt. Fixing portion 13 is provided over the entirety of circumference. Fixing clutch control unit 50 to fixing portion 13 forms clutch housing chamber 3.

Clutch control unit 50 is provided with a through hole penetrating through in the axial direction. Input shaft 31 of clutch 30 is inserted through the through hole and is supported so as to be relatively rotatable with respect to clutch control unit 50.

In clutch control unit 50, a plurality of valves for controlling the operation of the lock-up clutch of torque converter 20, the operation of clutch 30, and the supply of a lubricating oil to clutch 30 are disposed, and a hydraulic oil passage through which the hydraulic oil flows is formed.

The hydraulic oil pumped up from oil pan 52 by oil pump 51 is supplied to the hydraulic oil passage of clutch control unit 50. Oil pump 51 is integrally provided on the rear side of a lower portion of clutch control unit 50. Thus, oil pump 51 is disposed on the front side relative to clutch 30 in clutch housing chamber 3.

Transmission control unit 60 will be described with reference to FIG. 1A and FIG. 1B. FIG. 1B is a cross-sectional view taken along 1B-1B of FIG. 1A. Transmission control unit 60 is attached to the front surface of partition wall 12 by a fixing unit, such as a bolt. That is, gear-shifting control unit 60 is disposed in clutch housing chamber 3.

As illustrated in FIG. 1A and FIG. 1B, gear-shifting control unit 60 is disposed radially outward of clutch 30. More specifically, gear-shifting control unit 60 is disposed on an upper side of clutch 30. Further, as illustrated in FIG. 1A and FIG. 1B, gear-shifting control unit 60 has a substantially rectangular parallelepiped shape.

A plurality of valves is disposed in gear-shifting control unit 60, including a pressure control valve for controlling the supply of a hydraulic oil to gear-shifting control actuator unit 70 for operating gear-shifting elements of transmission mechanism 40, a switching valve, and/or the like. Further, a hydraulic oil passage through which the hydraulic oil flows is formed in gear-shifting control unit 60.

The hydraulic oil passage of clutch control unit 50 and the hydraulic oil passage of gear-shifting control unit 60 are connected with each other via oil passage pipe 61 disposed in clutch housing chamber 3. The hydraulic oil supplied from oil pump 51 flows to gear-shifting control unit 60 through clutch control unit 50 and oil passage pipe 61.

Gear-shifting control actuator unit 70 will be described with reference to FIG. 1A and FIG. 1C. FIG. 1C is a cross-sectional view taken along 1C-1C of FIG. 1A. Gear-shifting control actuator unit 70 is attached to the rear surface of partition wall 12 by a fixing unit, such as a bolt. That is, gear-shifting control actuator unit 70 is disposed in transmission mechanism housing chamber 4.

As illustrated in FIG. 1A and FIG. 1C, gear-shifting control actuator unit 70 is disposed so as to axially overlap with gear-shifting control unit 60. Further, as illustrated in FIG. 1A and FIG. 1C, an axially cross-sectional shape of gear-shifting control actuator unit 70 is a substantially arc shape (or substantially L-shape) surrounding transmission mechanism 40.

In gear-shifting control actuator unit 70, a piston for axially moving a shift fork (not illustrated) fixed to shift rod 71 is disposed, and a hydraulic oil passage through which the hydraulic oil flows is formed.

The hydraulic oil passage of gear-shifting control unit 60 and the hydraulic oil passage of gear-shifting control actuator unit 70 are connected with each other via oil passage 72 provided in partition wall 12. The hydraulic oil from gear-shifting control unit 60 is supplied to each piston oil chamber in gear-shifting control actuator unit 70.

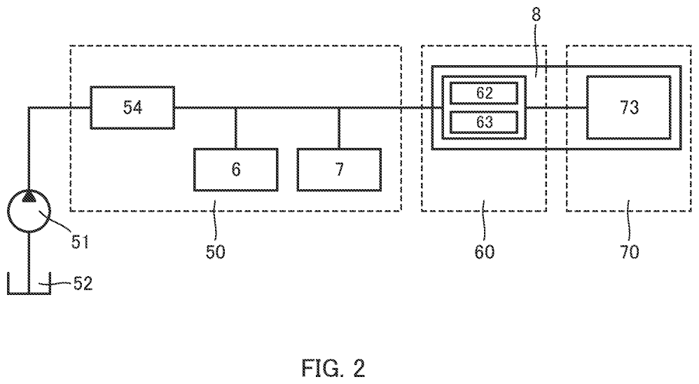

Referring to FIG. 2, a hydraulic circuit extending from oil pump 51 to gear-shifting control actuator unit 70 will be briefly described, herein.

The hydraulic oil pumped up from oil pan 52 by oil pump 51 is adjusted in pressure to a line pressure by line pressure control valve 54. The hydraulic oil adjusted in pressure to the line pressure is supplied to each of clutch operation control circuit 6, clutch lubrication control circuit 7, and gear-shifting control circuit 8.

As illustrated in FIG. 2, line pressure control valve 54, clutch operation control circuit 6, and clutch lubrication control circuit 7 are provided in clutch control unit 50. Further, among the components constituting gear-shifting control circuit 8, a plurality of pressure control valves 62 and a plurality of switching valves 63 are provided in gear-shifting control unit 60, and a plurality of pistons 73 is provided in gear-shifting control actuator unit 70.

As described above, according to the first embodiment, gear-shifting control unit 60 in which the valves for performing the gear-shifting control are disposed is disposed in clutch housing chamber 3. Thus, gear-shifting control unit 60 can be disposed near clutch control unit 50, which makes it possible to shorten the oil passage pipe connecting between both of the units. Therefore, it is made possible to suppress an increase in size of automatic transmission 1.

Further, according to the first embodiment, gear-shifting control unit 60 is disposed radially outward of clutch 30. Thus, it is made possible to suppress an increase in length of the axial dimension of clutch housing chamber 3.

Further, according to the first embodiment, gear-shifting control unit 60 is fixed to the front surface of partition wall 12. Thus, the oil passage connecting between gear-shifting control unit 60 and gear-shifting control actuator unit 70 can be provided in partition wall 12.

Moreover, according to the first embodiment, oil pump 51 for supplying the hydraulic oil to gear-shifting control unit 60 is provided in clutch housing chamber 3. Thus, providing an oil pan in transmission mechanism housing chamber 4 is no longer necessary, so that it is made possible to suppress an increase in size of transmission mechanism housing chamber 4. Further, it is made possible to shorten the oil passage from oil pump 51 to gear-shifting control unit 60.

Further, according to the first embodiment, clutch control unit 50 for controlling clutch 30 is disposed on a front side relative to clutch 30, and oil pump 51 is integrally provided with clutch control unit 50. Thus, oil pump 51, clutch control unit 50 and gear-shifting control unit 60 can be disposed adjacent to each other, and thus, it is made possible to shorten the oil passage.

### Second Embodiment

FIG. 3 is a schematic cross-sectional view of automatic transmission 101 according to a second embodiment of the present disclosure. The second embodiment is different from the first embodiment in configurations of a gear-shifting control unit and a gear-shifting control actuator unit. The components identical to those of the first embodiment are denoted by the same reference numerals, and their names and functions are the same. Accordingly, a detailed description of these components is omitted.

In the second embodiment, all of the components constituting gear-shifting control circuit 8 (specifically, pressure control valve 62, switching valve 63 and piston 73) are disposed in gear-shifting control unit 160. Gear-shifting control unit 160 is formed by integrating, into a single unit, gear-shifting control unit 60 and gear-shifting control actuator unit 70 in the first embodiment.

Hereinafter, for the sake of convenience, a portion where pressure control valve 62 and switching valve 63 are disposed in gear-shifting control unit 160 is referred to as “first portion 164,” and a portion where piston 73 is disposed is referred to as “second portion 165.”

Partition wall 112 of housing 110 is provided with hole 114 through which first portion 164 is inserted from the rear side to the front side. Gear-shifting control unit 160 is inserted into hole 114 and attached to partition wall 112 by a fixing unit, such as a bolt, thereby fixing gear-shifting control unit 160 to housing 110.

In automatic transmission 101 configured in the manner described above, among the components constituting gear-shifting control circuit 8, pressure control valve 62 and switching valve 63 are disposed in clutch housing chamber 3, and piston 73 is disposed in transmission mechanism housing chamber 4.

As described above, according to the second embodiment, first portion 164 in which the valves for performing the gear-shifting control are disposed in gear-shifting control unit 160 is disposed in clutch housing chamber 3. Thus, gear-shifting control unit 160 can be disposed near clutch control unit 50, which makes it possible to shorten the oil passage pipe connecting between both of the units. Therefore, it is made possible to suppress an increase in size of automatic transmission 101.

Further, according to the second embodiment, first portion 164 of gear-shifting control unit 160 is disposed radially outward of clutch 30. Thus, it is made possible to suppress an increase in length of the axial dimension of clutch housing chamber 3.

Further, according to the second embodiment, gear-shifting control unit 160 penetrates through partition wall 112 and is fixed to partition wall 112. Thus, providing an oil passage connecting between first portion 164 and second portion 165 of gear-shifting control unit 160 in partition wall 112 is unnecessary.

### Third Embodiment

FIG. 4 is a schematic cross-sectional view of automatic transmission 201 according to a third embodiment of the present disclosure. The third embodiment is different from the first embodiment and the second embodiment in configurations of a gear-shifting control unit and a gear-shifting control actuator unit. The components identical to those of the first embodiment are denoted by the same reference numerals, and their names and functions are the same. Therefore, a detailed description thereof is omitted.

In the third embodiment, in addition to gear-shifting control unit 260, gear-shifting control actuator unit 270 is also disposed in clutch housing chamber 3. Gear-shifting control actuator unit 270 is fixed directly to gear-shifting control unit 260 on the rear side of gear-shifting control unit 260. Note that, gear-shifting control actuator unit 270 may be disposed circumferentially adjacent to gear-shifting control unit 260.

Partition wall 212 of housing 210 is provided with hole 214 through which shift rod 271 extending rearward from gear-shifting control actuator unit 270 is inserted. Attaching gear-shifting control actuator unit 270 to the front surface of partition wall 212 fixes gear-shifting control unit 260 and gear-shifting control actuator unit 270 with respect to housing 210.

Note that, hole 214 may be formed in such a shape that fits to the outer shape of gear-shifting control actuator unit 270, so that gear-shifting control actuator unit 270 is fixed to partition wall 212 in a state of being inserted into hole 214. In addition, in a case where gear-shifting control unit 260 and gear-shifting control actuator unit 270 are disposed circumferentially adjacent to each other, gear-shifting control unit 260 may be attached to the front surface of partition wall 212.

As described above, according to the third embodiment, gear-shifting control unit 260 in which the valves for performing the gear-shifting control are disposed is disposed in clutch housing chamber 3. Thus, gear-shifting control unit 260 can be disposed near clutch control unit 50, thereby making it possible to shorten the oil passage pipe connecting between both of the units. Therefore, it is made possible to suppress an increase in size of automatic transmission 201.

Further, according to the third embodiment, gear-shifting control actuator unit 270 in which the actuator for performing the gear-shifting control is disposed is also disposed in clutch housing chamber 3. Further, gear-shifting control actuator unit 270 is fixed directly to gear-shifting control unit 260. Thus, providing an oil passage connecting between gear-shifting control unit 260 and gear-shifting control actuator unit 270 in partition wall 212 is unnecessary.

In the first to the third embodiments described above, a description has been given with a dual clutch transmission (DCT) having two clutches, as an example, but the present disclosure is not limited to this case. The present disclosure is also applicable to automatic transmissions, such as an automatic mechanical transmission (AMT) having a single clutch.

This application is based on Japanese Patent Application No. 2018-165804, filed on Sep. 5, 2018, the contents of which are incorporated herein by reference.

### INDUSTRIAL APPLICABILITY

According to the automatic transmission of the present disclosure, it is made possible to suppress an increase in size, and the industrial applicability is significant.

### REFERENCE SIGNS LIST

1, 101, 201 Automatic transmission
2 Torque converter housing chamber
3 Clutch housing chamber
4 Transmission mechanism housing chamber
6 Clutch operation control circuit
7 Clutch lubrication control circuit
8 Gear-shifting control circuit
10, 110, 210 Housing
11 Peripheral wall
12, 112, 212 Partition wall
13 Fixing portion
114, 214 Hole
20 Torque converter
21 Output shaft
30 Clutch
31 Input shaft
40 Transmission mechanism
41 First input shaft
42 Second input shaft
50 Clutch control unit
51 Oil pump
52 Oil pan
54 Line pressure control valve
60, 160, 260 Gear-shifting control unit
61 Oil passage pipe
62 Pressure control valve
63 Switching valve
164 First portion
165 Second portion
70, 270 Gear-shifting control actuator unit
71, 271 Shift rod
72 Oil passage
73 Piston

1. An automatic transmission, comprising:
a transmission mechanism disposed in a transmission mechanism housing chamber and having a plurality of gear-shifting elements;
a clutch disposed in a clutch housing chamber and configured to connect and/or disconnect power transmission from a driving source to the transmission mechanism; and
a first control unit that houses a first hydraulic control valve configured to control the transmission mechanism, wherein
the first control unit is disposed in the clutch housing chamber.

2. The automatic transmission according to claim 1, wherein the first control unit is provided on a radially outer side of the clutch.

3. The automatic transmission according to claim 1, wherein the first control unit is fixed to a partition wall that serves as a partition between the transmission mechanism housing chamber and the clutch housing chamber.

4. The automatic transmission according to claim 1, further comprising an actuator for operating the gear-shifting elements, wherein the actuator is disposed in the transmission mechanism housing chamber.

5. The automatic transmission according to claim 1, further comprising an actuator for operating the gear-shifting elements, wherein the actuator is disposed in the clutch housing chamber.

6. The automatic transmission according to claim 4, wherein the actuator is integrally provided on a rear side of the first control unit.

7. The automatic transmission according to claim 1, further comprising an oil pump that supplies the first control unit with a hydraulic oil, wherein the oil pump is disposed on a front side relative to the clutch in the clutch housing chamber.

8. The automatic transmission according to claim 7, further comprising a second control unit disposed on a front side relative to the clutch and configured to control the clutch, wherein the oil pump is integrally provided to the second control unit.

9. The automatic transmission according to claim 8, further comprising an oil passage pipe connecting between the second control unit and the first control unit, wherein the hydraulic oil is supplied to the first control unit through the second control unit and the oil passage pipe.
